(19) United States
(12) Patent Application Publication
(10) Pub. No.: US 2025/0245853 A1
(43) Pub. Date: Jul. 31, 2025

(54) SYSTEM AND METHOD FOR GENERATING CODE BLOCK MAP BASED ON FLOOR PATTERN RECOGNITION AND SYSTEM AND METHOD FOR RECOGNIZING LOCATION AND ORIENTATION OF ROBOT BASED ON FLOOR PATTERN CODE STRING

(71) Applicant: KOREA INSTITUTE OF ROBOT & CONVERGENCE, Pohang-si (KR)

(72) Inventors: Kap Ho SEO, Pohang-si (KR); Kyon Mo YANG, Seoul (KR); Ji Won LEE, Seoul (KR); Jae Wan KOO, Pohang-si (KR); Yu Jin CHO, Seoul (KR)

(73) Assignee: KOREA INSTITUTE OF ROBOT & CONVERGENCE, Pohang-si (KR)

(21) Appl. No.: 18/668,214

(22) Filed: May 19, 2024

(30) Foreign Application Priority Data
Jan. 29, 2024 (KR) 10-2024-0013189
Jan. 29, 2024 (KR) 10-2024-0013190

(51) Int. Cl. G06T 7/73; G06T 3/60; G06V 10/75; G06V 20/56

(52) U.S. Cl. CPC G06T 7/74; G06T 3/60; G06V 10/75; G06V 20/56; G06T 2207/30252

(57) ABSTRACT

Provided is a technology for recognizing a location or orientation of a robot using patterns of a floor on which the robot travels, and the technology includes two interrelated sub-technologies. The first sub-technology is a technology for generating a code block map based on floor pattern recognition, in which a code block map is generated using patterns of a floor on which a robot travels, and the second sub-technology is a technology for recognizing a location and orientation of a robot based on a floor pattern code string, in which a location and orientation of a traveling robot are recognized using a generated code block map.

### CROSS-REFERENCE TO RELATED APPLICATION

This application claims priority to and the benefit of Korean Patent Application Nos. 10-2024-0013189, 10-2024-0013190 filed on Jan. 29, 2024, the disclosure of which is incorporated herein by reference in its entirety.

### BACKGROUND

### 1. Field of the Invention

The present invention relates to a system and method for generating a code block map based on floor pattern recognition and a system and method for recognizing a location and orientation of a robot based on a floor pattern code string, and more particularly, to a system and method for recognizing a location and orientation of a robot which travels in a predetermined space using floor patterns imaged through a camera installed in the robot.

### 2. Discussion of Related Art

With the development of information and communication technology, robotics technology, autonomous driving technology, computer technology, and the like, various autonomous driving robots have been developed and commercialized, including cleaning robots used in homes, service robots used in restaurants and hospitals, mobile robots used to transport materials in industrial sites, and the like.

In the automotive sector, fully autonomous cars are expected to appear in the near future, and in the aviation sector, unmanned drones are being developed very actively.

These various types of autonomous driving robots are equipped with a variety of sensors to recognize their locations or nearby obstacles and set optimal travel paths for avoiding the obstacles.

Sensors installed in autonomous driving robots for this purpose include a Global Positioning System (GPS) sensor, an ultrasonic sensor, an infrared sensor, a laser sensor, a light detection and ranging (LiDAR) sensor, a camera sensor, and the like.

As described above, information on environments in which a robot travels is mainly acquired using a distance sensor (using LiDAR, a laser, ultrasonic waves, infrared light, or the like) attached to the robot or acquired through an image processing process using a vision sensor such as a camera or the like.

Also, autonomous robots are mainly equipped with a motor encoder, infrared and ultrasonic sensors, and the like to recognize locations thereof on the basis of odometer information and recognize the presence of obstacles.

Meanwhile, in the mapping method through LiDAR-based simultaneous localization and mapping (SLAM) according to the related art, movable, unmovable, and unexplored areas are determined and plotted on a grid map on the basis of recognition results of sensors, and thus various information on surroundings is not included in the map.

Therefore, in spaces without feature points or spaces such as long corridors, autonomous driving robots are prone to errors in determining their positions or orientations.

On the other hand, in the case of a map fused with image information, there is a problem that the image information contains too much information, which increases the data size of the map and requires a large amount of computation in the process of comparing images when recognizing the location and orientation of the robot.

Meanwhile, Korean Patent No. 10-2555708 B1 (registered on Jul. 11, 2023) discloses a location recognition and driving control method for an autonomous driving robot which tracks a grid pattern, but the patent is limited to a method of controlling travel by detecting the edges of tiles.

### SUMMARY OF THE INVENTION

The present invention is directed to providing a system and method for recognizing a location and orientation of a robot based on a floor pattern code string, which are intended to reduce the amount of computation of travel environment information in a space having floor tiles and wall tiles with repetitive patterns.

Objects to be addressed by the present invention are not limited to that described above, and other objects which have not been described will be clearly understood by those skilled in the technical field to which the present invention pertains from this specification and the accompanying drawings.

According to an aspect of the present invention, there is provided a system for recognizing a location and orientation of a robot based on a floor pattern code, which is a system for recognizing a location and orientation of a robot using floor patterns imaged through a camera installed in the robot, the system including a map acquisition unit configured to extract unit patterns from floor patterns of the predetermined space and acquire a code block map which is generated by assigning predetermined identification codes to the unit patterns, a travel image acquisition unit configured to acquire a travel image of floor patterns imaged through the camera, a travel unit pattern extractor configured to extract travel unit patterns from the floor patterns included in the travel image, a code string generator configured to generate a floor pattern code string by identifying predetermined travel identification codes corresponding to the travel unit patterns, and a calculator configured to calculate a location and orientation of the robot by comparing the floor pattern code string with the identification codes of the code block map.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a schematic block diagram of a system for generating a code block map based on floor pattern recognition and a system for recognizing a location and orientation of a robot based on a floor pattern code string according to the present invention;

FIG. 2 is a schematic diagram illustrating floor patterns which are subjects in a captured image of the system for generating a code block map based on floor pattern recognition according to the present invention;

FIGS. 3a-3d are a set of schematic diagrams illustrating a code assignment unit of the system for generating a code block map based on floor pattern recognition according to the present invention;

FIG. 4 is a schematic diagram of a code block map generated by a map generator of the system for generating a code block map based on floor pattern recognition according to the present invention;

FIGS. 5a and 5b are a set of schematic diagrams illustrating a function of the map generator of the system for generating a code block map based on floor pattern recognition according to the present invention;

FIG. 6 is a schematic diagram illustrating other floor patterns which are subjects in a captured image of the system for generating a code block map based on floor pattern recognition according to the present invention;

FIGS. 7a and 7b are a set of schematic diagrams illustrating, on the basis of the floor pattern of FIG. 6, the code assignment unit of the system for generating a code block map based floor pattern recognition according to the present invention;

FIG. 8 is a schematic diagram of a code block map generated on the basis of the floor pattern of FIG. 6 by the map generator of the system for generating a code block map based on floor pattern recognition according to the present invention;

FIG. 9 is a schematic flowchart illustrating a method of generating a code block map based on floor pattern recognition according to the present invention;

FIGS. 10a and 10b are a set of schematic diagrams illustrating a travel image acquisition unit and a travel unit pattern extractor of the system for recognizing a location and orientation of a robot based on a floor pattern code string according to the present invention;

FIGS. 11 and 12 are schematic diagrams illustrating a code string generator of the system for recognizing a location and orientation of a robot based on a floor pattern code string according to the present invention;

FIG. 13 is a schematic diagram illustrating a calculator of the system for recognizing a location and orientation of a robot based on a floor pattern code string according to the present invention;

FIGS. 14a and 14b are a set of other schematic diagrams illustrating the travel image acquisition unit and the travel unit pattern extractor of the system for recognizing a location and orientation of a robot based on a floor pattern code string according to the present invention;

FIG. 15 is another schematic diagram illustrating the code string generator of the system for recognizing a location and orientation of a robot based on a floor pattern code string according to the present invention; and

FIG. 16 is a schematic flowchart illustrating a method of recognizing a location and orientation of a robot based on a floor pattern code string according to the present invention.

### DETAILED DESCRIPTION OF EXEMPLARY EMBODIMENTS

Hereinafter, exemplary embodiments of the present invention will be described in detail. The spirit of the present invention is not limited to the proposed embodiments. Those of ordinary skill in the art who understand the spirit of the present invention can easily propose other backward inventions or other embodiments within the scope of the spirit of the present invention by adding, changing, or removing components within the scope of the same spirit, and those also fall within the scope of the present invention.

A system for generating a code block map based on floor pattern recognition according to an exemplary embodiment of the present invention relates to a system that generates a code block map using patterns of a floor on which a robot travels, the system including an image acquisition unit configured to acquire a captured image of a floor from a camera, a unit pattern extractor configured to extract unit patterns from patterns of the floor included in the captured image, a code assignment unit configured to assign predetermined identification codes to the unit patterns, and a map generator configured to generate blocks corresponding to the unit patterns and generate a code block map by matching the identification codes to the blocks corresponding to the unit patterns.

The code assignment unit may generate rotated unit patterns by rotating the unit patterns by a predetermined angle and assign rotation identification codes to the rotated unit patterns, and the map generator may generate blocks corresponding to the rotated unit patterns and generate the code block map by matching the rotation identification codes to the blocks corresponding to the rotated unit patterns.

The rotation identification codes may include information on the predetermined angle by which the unit patterns are rotated to be the rotated unit patterns.

The code assignment unit may assign no rotation identification code to the rotated unit patterns when the unit patterns are identical to the rotated unit patterns.

A method of generating a code block map based on floor pattern recognition according to another exemplary embodiment of the present invention relates to a method of generating a code block map using patterns of a floor on which a robot travels, the method including an operation in which an image acquisition unit acquires a captured image of a floor from a camera, an operation in which a unit pattern extractor extracts unit patterns from patterns of the floor included in the captured image, an operation in which a code assignment unit assigns predetermined identification codes to the unit patterns, and an operation in which a map generator generates blocks corresponding to the unit patterns and generates a code block map by matching the identification codes to the blocks corresponding to the unit patterns.

In the operation in which the code assignment unit assigns the predetermined identification codes, the code assignment unit may generate rotated unit patterns by rotating the unit patterns by a predetermined angle and assign rotation identification codes to the rotated unit patterns, and in the operation in which the map generator generates the code block map, the map generator may generate blocks corresponding to the rotated unit patterns and generate the code block map by matching the rotation identification codes to the blocks corresponding to the rotated unit patterns.

The rotation identification codes may include information on the predetermined angle by which the unit patterns are rotated to be the rotated unit patterns.

In the operation in which the code assignment unit assigns the predetermined identification codes, the code assignment unit may assign no rotation identification code to the rotated unit patterns when the unit patterns are identical to the rotated unit patterns.

Meanwhile, a system for recognizing a location and orientation of a robot based on a floor pattern code string according to another exemplary embodiment of the present invention relates to a system for recognizing a location and orientation of a robot which travels in a predetermined space using floor patterns imaged through a camera installed in the robot, the system including a map acquisition unit configured to extract unit patterns from floor patterns of the predetermined space and acquire a code block map which is generated by assigning predetermined identification codes to the unit patterns, a travel image acquisition unit configured to acquire a travel image of floor patterns imaged through the camera, a travel unit pattern extractor configured to extract travel unit patterns from the floor patterns included in the travel image, a code string generator configured to generate a floor pattern code string by identifying predetermined travel identification codes corresponding to the travel unit patterns, and a calculator configured to calculate a location and orientation of the robot by comparing the floor pattern code string with the identification codes of the code block map.

When the floor pattern code string does not match the identification codes of the code block map, the calculator may generate a corrected floor pattern code string by correcting the travel identification codes using a predetermined rotation value and calculate the location and orientation of the robot by comparing the corrected floor pattern code string with the identification codes of the code block map.

When the floor pattern code string does not match the identification codes of the code block map, the calculator may generate a rotated code block map by correcting the identification codes of the code block map using a predetermined rotation value and calculate the location and orientation of the robot by comparing the floor pattern code string with the corrected identification codes of the rotated code block map.

The code string generator may change the number of travel identification codes included in the floor pattern code string according to at least one of the types and number of identification codes included in the code block map.

A method of recognizing a location and orientation of a robot based on a floor pattern code string according to another exemplary embodiment of the present invention relates to a method of recognizing a location and orientation of a robot which travels in a predetermined space using floor patterns imaged through a camera installed in the robot, the method including an operation in which a map acquisition unit extracts unit patterns from floor patterns of the predetermined space and acquires a code block map which is generated by assigning predetermined identification codes to the unit patterns, an operation in which a travel image acquisition unit acquires a travel image of floor patterns imaged through the camera, an operation in which a travel unit pattern extractor extracts travel unit patterns from the floor patterns included in the travel image, an operation in which a code string generator identifies predetermined travel identification codes corresponding to the travel unit patterns and generates a floor pattern code string, and an operation in which a calculator calculates a location and orientation of the robot by comparing the floor pattern code string with the identification codes of the code block map.

In the operation in which the calculator calculates the location and orientation of the robot, when the floor pattern code string does not match the identification codes of the code block map, a corrected floor pattern code string may be generated by correcting the travel identification codes using a predetermined rotation value, and the location and orientation of the robot may be calculated by comparing the corrected floor pattern code string with the identification codes of the code block map.

In the operation in which the calculator calculates the location and orientation of the robot, when the floor pattern code string does not match the identification codes of the code block map, a rotated code block map may be generated by correcting the identification codes of the code block map using a predetermined rotation value, and the location and orientation of the robot may be calculated by comparing the floor pattern code string with the corrected identification codes of the rotated code block map.

In the operation in which the code string generator generates the floor pattern code string, the number of travel identification codes included in the floor pattern code string may be changed according to at least one of the types and number of identification codes included in the code block map.

Throughout the drawings, components with the same function within the same spirit will be described using the same reference numeral.

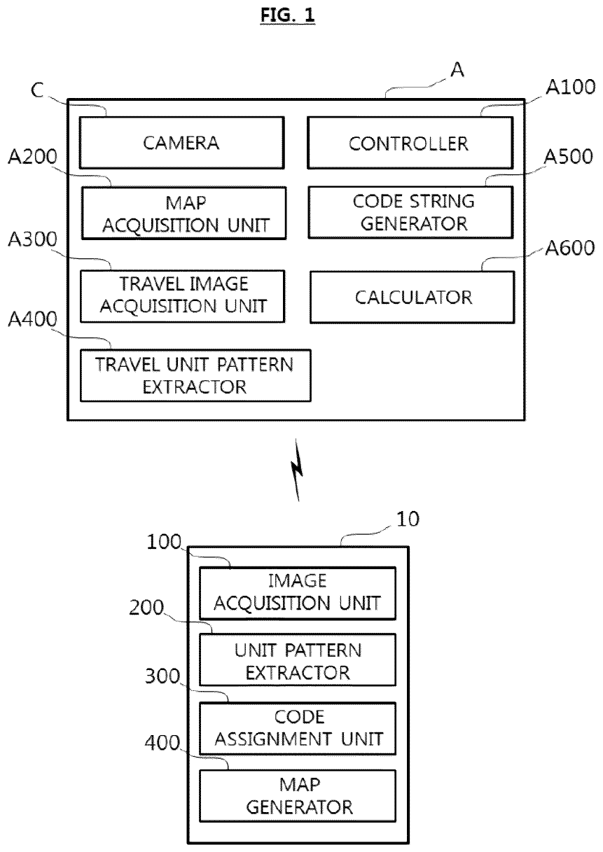

FIG. 1 is a schematic block diagram of a system for generating a code block map based on floor pattern recognition and a system for recognizing a location and orientation of a robot based on a floor pattern code string according to the present invention.

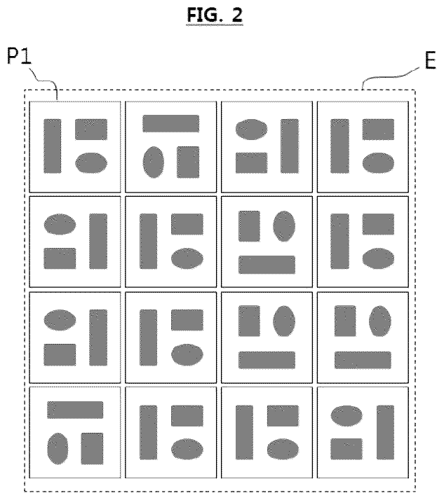

FIG. 2 is a schematic diagram illustrating floor patterns which are subjects in a captured image of the system for generating a code block map based on floor pattern recognition according to the present invention.

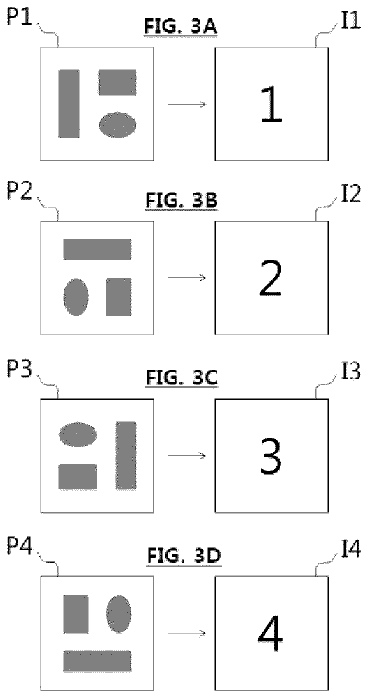

FIGS. 3a-3d are a set of schematic diagrams illustrating a code assignment unit of the system for generating a code block map based on floor pattern recognition according to the present invention.

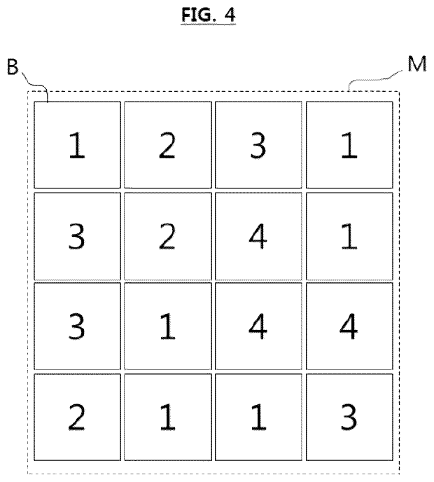

FIG. 4 is a schematic diagram of a code block map generated by a map generator of the system for generating a code block map based on floor pattern recognition according to the present invention.

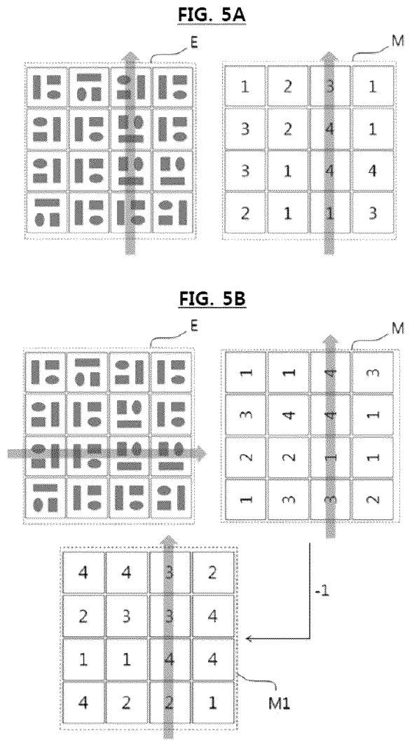

FIGS. 5a and 5b are a set of schematic diagrams illustrating a function of the map generator of the system for generating a code block map based on floor pattern recognition according to the present invention.

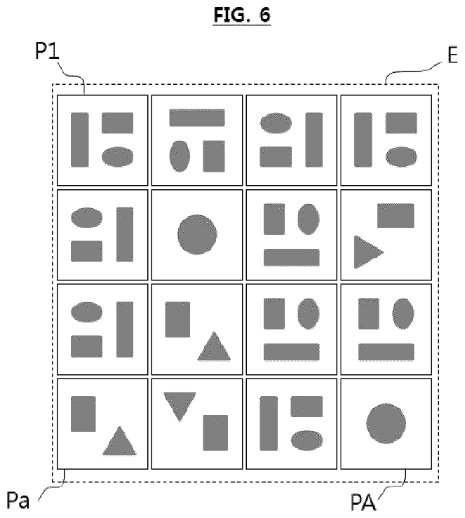

FIG. 6 is a schematic diagram illustrating other floor patterns which are subjects in a captured image of the system for generating a code block map based on floor pattern recognition according to the present invention.

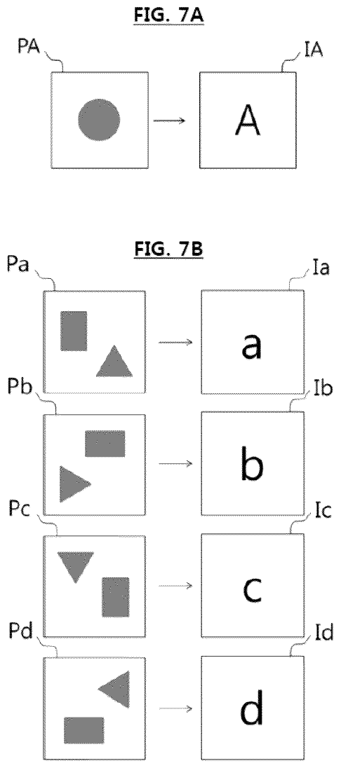

FIGS. 7a and 7b are a set of schematic diagrams illustrating, on the basis of the floor pattern of FIG. 6, the code assignment unit of the system for generating a code block map based on floor pattern recognition according to the present invention.

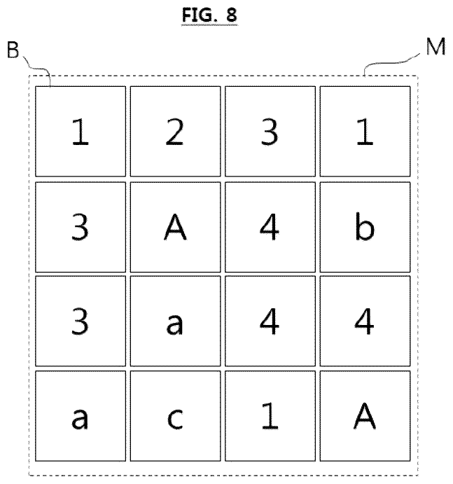

FIG. 8 is a schematic diagram of a code block map generated on the basis of the floor pattern of FIG. 6 by the map generator of the system for generating a code block map based on floor pattern recognition according to the present invention.

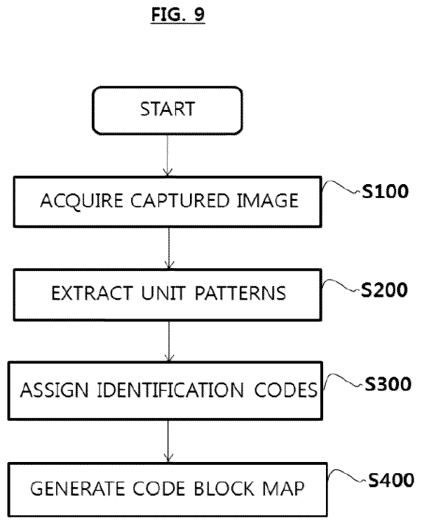

FIG. 9 is a schematic flowchart illustrating a method of generating a code block map based on floor pattern recognition according to the present invention.

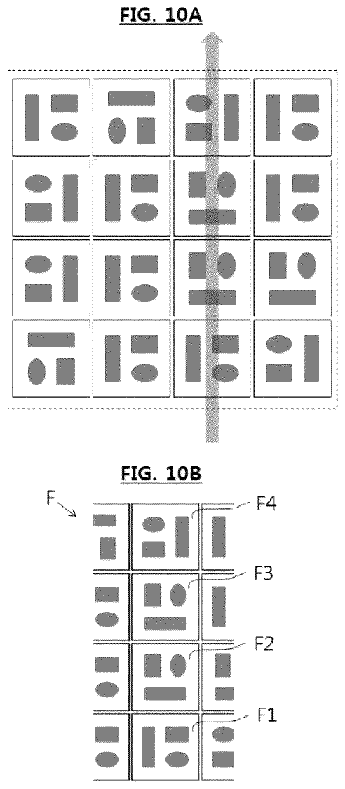

FIGS. 10a and 10b are a set of schematic diagrams illustrating a travel image acquisition unit and a travel unit pattern extractor of the system for recognizing a location and orientation of a robot based on a floor pattern code string according to the present invention.

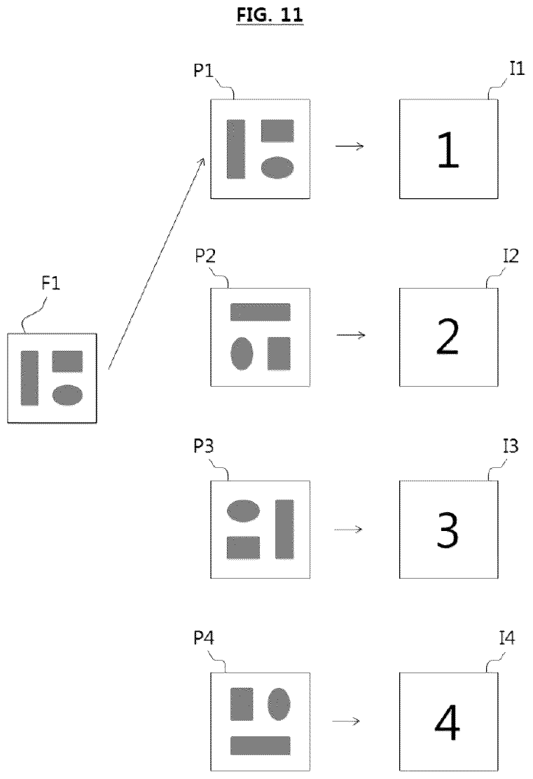

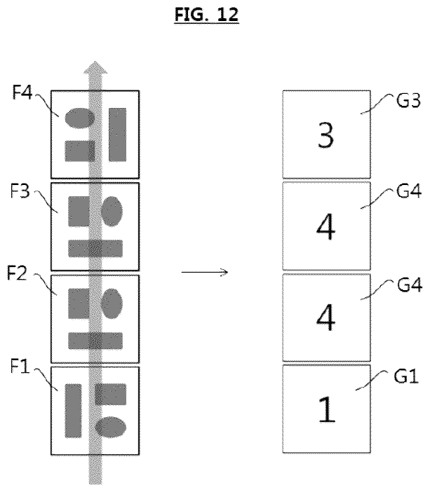

FIGS. 11 and 12 are schematic diagrams illustrating a code string generator of the system for recognizing a location and orientation of a robot based on a floor pattern code string according to the present invention.

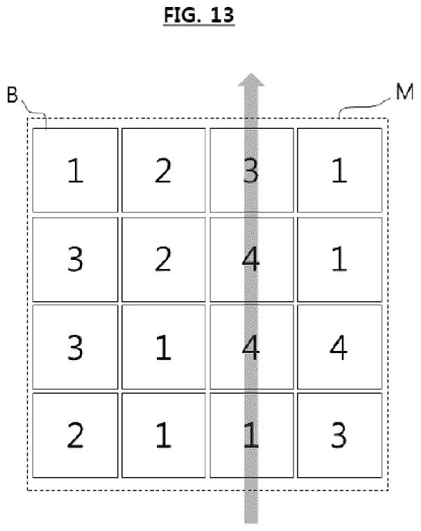

FIG. 13 is a schematic diagram illustrating a calculator of the system for recognizing a location and orientation of a robot based on a floor pattern code string according to the present invention.

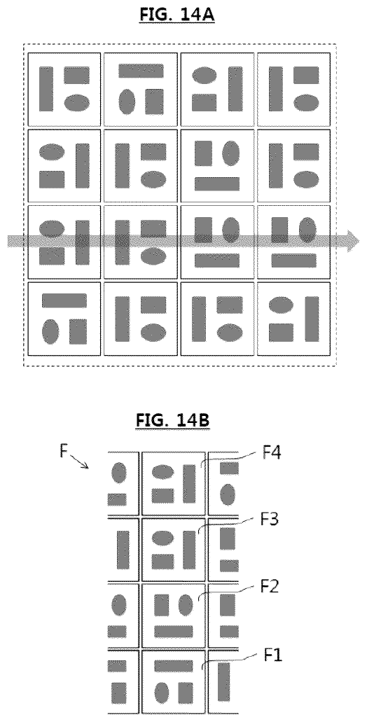

FIGS. 14a and 14b are a set of other schematic diagrams illustrating the travel image acquisition unit and the travel unit pattern extractor of the system for recognizing a location and orientation of a robot based on a floor pattern code string according to the present invention.

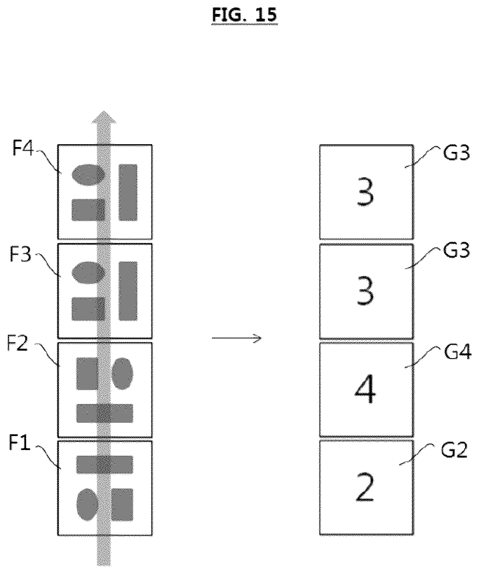

FIG. 15 is another schematic diagram illustrating the code string generator of the system for recognizing a location and orientation of a robot based on a floor pattern code string according to the present invention.

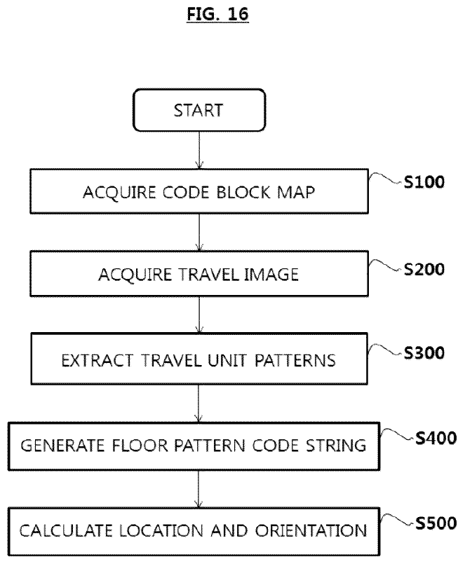

FIG. 16 is a schematic flowchart illustrating a method of recognizing a location and orientation of a robot based on a floor pattern code string according to the present invention.

Throughout the accompanying drawings, parts that are irrelevant to the technical spirit of the present invention or easily deducible by those of ordinary skill in the art are simplified or omitted to clearly describe the technical spirit of the present invention.

Throughout the specification, when a part is referred to as being “connected” to another part, the two parts may be “directly connected” or may be “indirectly connected” with an intermediate element therebetween. Also, when a part is referred to as “including” a component, other components are not excluded but may be further included unless specifically described otherwise. This does not preclude the presence or addition of one or more other features, integers, steps, operations, components, parts, or combinations thereof.

In this specification, the term “unit” includes a unit implemented by hardware, a unit implemented by software, and a unit implemented by both. Here, one unit may be implemented using two or more pieces of hardware, and two or more units may be implemented by one piece of hardware.

In this specification, some operations or functions described as being performed by a terminal or device may be performed by a server connected to the terminal or device instead. Similarly, some operations or functions described as being performed by a server may be performed by a terminal or device connected to the server.

The present invention relates to a technology for recognizing a location or orientation of a robot using patterns of a floor on which the robot travels, and may include two interrelated sub-technologies.

The first sub-technology is a technology for generating a code block map based on floor pattern recognition, in which a code block map is generated using patterns of a floor on which a robot travels, and the second sub-technology is a technology for recognizing a location and orientation of a robot based on a floor pattern code string, in which a location and orientation of a traveling robot are recognized using a generated code block map.

For convenience in describing the present invention, a system and method for generating a code block map based on floor pattern recognition will be first described in detail as the first sub-technology, and then a system for recognizing a location and orientation of a robot based on a floor pattern code string and a method of recognizing a location and orientation of a robot based on a floor pattern code string which is implemented by the system will be described as the second sub-technology.

### 1. System and Method for Generating Code Block Map Based on Floor Pattern Recognition

A system 10 for generating a code block map based on floor pattern recognition according to an exemplary embodiment of the present invention and a method of generating a code block map based on floor pattern recognition which is implemented by the system 10 will be described in detail below with reference to FIGS. 1 to 9.

The system 10 may be mainly characterized in that patterns of a floor on which a robot A travels are used to generate a code block map M which is used for the robot A to recognize its location, orientation, and the like.

For example, as shown in FIG. 1, the system 10 may include an image acquisition unit 100, a unit pattern extractor 200, a code assignment unit 300, and a map generator 400, which will be described in detail below.

Although not shown in the drawing, the system 10 may further include a communication unit for communication with other devices, such as the robot A and the like, an input unit for receiving a predetermined formula, instruction, and the like from a manager, a display unit for displaying predetermined information and data, and a memory unit for storing predetermined information and data.

Meanwhile, the system 10 may communicate with the robot A, which is equipped with a camera C and travels in a predetermined space, to acquire an image captured by the camera C.

The system 10 will be described in further detail below with reference to FIGS. 2 to 8.

The system 10 may include the image acquisition unit 100 for acquiring the captured image of the floor from the camera C.

For example, FIG. 2 shows an example of a captured image E, in which subjects may include a plurality of tiles (a total of 16 tiles arranged in four rows and four columns) covering the predetermined space in which the robot A travels. In the example, one type of tiles are installed in several directions, and thus the tiles have different patterns (figures, shapes, or the like) when viewed from one direction.

The captured image E may be an image of the floor on which the robot A travels. However, the captured image E is not limited thereto and may also be an image of a wall, a ceiling, or the like. Here, for convenience of description, the captured image E is assumed to be an image of the floor.

The image acquisition unit 100 may acquire the image E captured by the camera C from the camera C in a wired or wireless manner or through a mobile memory device or the like.

Meanwhile, the system 10 may further include a unit pattern extractor 200 for extracting unit patterns from patterns of the floor included in the captured image E.

More specifically, the unit pattern extractor 200 may extract any one tile P1 from the plurality of tiles, which are subjects included in the captured image E, and extract a pattern (which means a unit pattern) shown in the extracted tile P1.

In other words, the unit pattern extractor 200 may recognize the boundary (edges) of each of the plurality of tiles which are subjects of the captured image E, to distinguish each tile by the boundary and recognize and extract a unit pattern included in each tile.

The unit pattern extractor 200 may select and extract any one of the plurality of tiles distinguished by the boundaries and extract the unit pattern P1 which is a pattern shown in the extracted tile (e.g., extract a pattern of a tile in the first row and the first column which is the uppermost and leftmost tile in FIG. 2).

Meanwhile, the system 10 may further include the code assignment unit 300 for assigning predetermined identification codes to the unit patterns extracted by the unit pattern extractor 200.

More specifically, the code assignment unit 300 may assign the predetermined identification codes to the unit patterns extracted by the unit pattern extractor 200 so that the unit patterns may be distinguished from other patterns.

For example, as shown in FIG. 3A, the code assignment unit 300 may assign “1” to the unit pattern P1 of the tile in the first row and the first column in FIG. 2 as an identification code I1.

The code assignment unit 300 may generate rotated unit patterns by rotating the unit patterns by a predetermined angle and assign rotation identification codes to the rotated unit patterns.

More specifically, the code assignment unit 300 may generate the rotated unit patterns which are rotated to differ from the unit patterns, by rotating the unit patterns extracted by the unit pattern extractor 200 by a predetermined angle and assign the rotation identification codes to the rotated unit patterns.

For example, as shown in FIG. 3B, the code assignment unit 300 may rotate the unit pattern P1 shown in FIG. 3A 90 degrees clockwise. When the unit pattern P1 is rotated 90 degrees, a 90-degree rotated unit pattern P2 different from the unit pattern P1 may be generated, and “2” may be assigned to the 90-degree rotated unit pattern P2 as a rotation identification code I2.

Also, as shown in FIG. 3C, the code assignment unit 300 may rotate the unit pattern P1 shown in FIG. 3A 180 degrees clockwise. When the unit pattern P1 is rotated 180 degrees, a 180-degree rotated unit pattern P3 different from the unit pattern P1 may be generated, and “3” may be assigned to the 180-degree rotated unit pattern P3 as a rotation identification code I3.

Similarly, as shown in FIG. 3D, the code assignment unit 300 may rotate the unit pattern P1 shown in FIG. 3A 270 degrees clockwise. When the unit pattern P1 is rotated 270 degrees, a 270-degree rotated unit pattern P4 different from the unit pattern P1 may be generated, and “4” may be assigned to the 270-degree rotated unit pattern P4 as a rotation identification code I4.

Here, the rotation identification codes may include information on the angle by which the unit patterns are rotated to be the rotated unit patterns.

In other words, the code assignment unit 300 may assign the rotation identification code I2 of “2” to the rotated unit pattern P2 which is obtained by rotating the unit pattern P1 assigned the identification code I1 of “1” 90 degrees, and the rotation identification code of “2” may represent that the rotation identification code of “2” is the pattern P2 different from the unit pattern P1 of the identification code “1” and also represent that the pattern P2 is obtained by rotating the unit pattern P1 of the identification code “1” 90 degrees.

Similarly, the code assignment unit 300 may assign the rotation identification code I3 of “3” to the rotated unit pattern P3 which is obtained by rotating the unit pattern P1 assigned the identification code I1 of “1” 180 degrees, and the rotation identification code of “3” may represent that the rotation identification code of “3” is the pattern P3 different from the unit pattern P1 of the identification code “1” and also represent that the pattern P3 is obtained by rotating the unit pattern P1 of the identification code “1” 180 degrees.

Further, the code assignment unit 300 may assign the rotation identification code I4 of “4” to the rotated unit pattern P4 which is obtained by rotating the unit pattern P1 assigned the identification code I1 of “1” 270 degrees, and the rotation identification code of “4” may represent that the rotation identification code of “4” is the pattern P4 different from the unit pattern P1 of the identification code “1” and also represent that the pattern P4 is obtained by rotating the unit pattern P1 of the identification code “1” 270 degrees.

The angle by which the unit pattern is rotated by the code assignment unit 300 and the number of rotations may be determined according to a shape formed by the boundary (edges) of one tile extracted by the unit pattern extractor 200 and an angle between the edges.

For example, when the edges of one tile are in a rectangular shape, the code assignment unit 300 may generate three rotated unit patterns in total by rotating the unit pattern 90 degrees, 180 degrees, and 270 degrees, and when the edges of one tile are in a hexagonal shape, the code assignment unit 300 may generate five rotated unit patterns in total by rotating the unit pattern 60 degrees, 120 degrees, 180 degrees, 240 degrees, and 300 degrees.

Meanwhile, the system 10 may further include a map generator 400 for generating blocks B corresponding to the unit patterns and assigning the identification codes to the blocks B corresponding to the unit patterns to generate a code block map M.

More specifically, the map generator 400 may match the identification codes assigned by the code assignment unit 300 to patterns of the floor on which the robot A travels, code the patterns of the floor, and define and generate the code block map M as a map of the floor.

For example, the map generator 400 may generate the blocks B corresponding to the unit patterns in the captured image E of FIG. 2. Here, the blocks B indicate areas corresponding to the boundaries of the plurality of tiles shown in FIGS. 2, and 16 blocks B may be formed in total in four rows and four columns.

Subsequently, the map generator 400 may assign the identification code and the rotation identification codes to the total of 16 blocks B, that is, the blocks B having the unit pattern and the rotated unit patterns.

In other words, as shown in FIG. 4, the map generator 400 may assign the identification code I1 of “1” to blocks B having the unit pattern P1 among the total of 16 blocks B.

Also, the map generator 400 may assign the rotation identification code I2 of “2” to blocks B having the 90-degree rotated unit pattern P2 among the total of 16 blocks B, assign the rotation identification code I3 of “3” to blocks B having the 180-degree rotated unit pattern P3, and assign the rotation identification code I4 of “4” to blocks B having the 270-degree rotated unit pattern P4.

Consequently, as shown in FIG. 4, the map generator 400 may generate the 16 blocks B to which the identification code and the rotation identification codes are assigned, for the plurality of tiles which are subjects of the captured image E shown in FIG. 2. Through this process, it is possible to generate the code block map M for the floor on which the robot A travels.

For example, the code block map M may include information in which the images of unit patterns corresponding to the identification code assigned to blocks B match the identification code, and information in which the images of the rotated unit patterns corresponding to the rotation identification codes match the rotation identification codes.

Meanwhile, the map generator 400 may further generate a rotated code block map M1 by rotating the code block map M at a predetermined angle.

More specifically, as shown in FIG. 5A, the map generator 400 may generate the code block map M by assigning the identification code and the rotation identification codes to the plurality of tiles which are the foregoing subjects of the captured image E shown in FIG. 2, and the code block map M may be a map of the captured image E captured by the robot A moving in a bottom-to-top direction (shown by an arrow) in the predetermined space.

As shown in FIG. 5B, the robot A may generate the captured image E through the camera C while moving in a left-to-right direction (shown by an arrow) in the same space. Accordingly, the map generator 400 does not newly generate the code block map M for the captured image E which is captured while the robot A moves in the left-to-right direction. Rather, the map generator 400 may rotate the code block map M for the captured image E, which is captured while the robot A moves in the bottom-to-top direction, 90 degrees counterclockwise (270 degrees clockwise) and change the identification code and the rotation identification codes assigned to the code block map M to correspond to the rotation angle, thus easily generating the rotated code block map M1 from the code block map M.

The system 10 will be described in further detail below with reference to FIGS. 6 to 8.

For example, FIG. 6 shows another example of the captured image E, in which subjects may include a plurality of tiles (a total of 16 tiles arranged in four rows and four columns) covering another predetermined space in which the robot A travels. In the example, three types of tiles are installed in several directions.

As described above with reference to FIGS. 2 to 4, the unit pattern extractor 200 may extract any one (e.g., the unit pattern P1 at the first row and the first column) of a plurality of unit patterns in a floor included in the captured image E, and the code assignment unit 300 may assign the identification code I1 and the rotation identification code I2, I3, and I4 to the unit pattern P1 in the first row and the first column and the rotated unit patterns P2, P3, and P4 generated by rotating the unit pattern P1. As shown in FIG. 8, the map generator 400 may generate a code block map M by assigning the codes “1,” “2,” “3,” and “4” to a plurality of blocks B.

In the floor pattern of FIG. 6, the unit pattern extractor 200 may extract at least one unit pattern (e.g., a unit pattern PA in the fourth row and the fourth column) from blocks B to which the code “1,” “2,” “3,” or “4” is not assigned (i.e., tiles having patterns different from the unit pattern in the first row and the first column and the rotated unit patterns of the unit pattern). As shown in FIG. 7A, the code assignment unit 300 may generate a rotated unit pattern by rotating the unit pattern PA in the fourth row and the fourth column by a predetermined angle.

The code assignment unit 300 may determine whether the unit pattern PA in the fourth row and the fourth column is identical to the rotated unit pattern generated by rotating the unit pattern PA. When the unit pattern PA is identical to the rotated unit pattern, the code assignment unit 300 may only assign an identification code IA to the unit pattern PA and may not assign any identification code to the rotated unit pattern.

As a result, the unit pattern PA in the fourth row and the fourth column may be assigned the identification code “A” and may not be assigned any rotation identification code.

Subsequently, as shown in FIG. 8, the map generator 400 may generate the code block map M by assigning the identification code IA to the block B in the second row and the second column which has a pattern identical to the unit pattern PA in the fourth row and the fourth column.

Similarly, in the floor pattern of FIG. 6, the unit pattern extractor 200 may extract at least one unit pattern (e.g., a unit pattern Pa in the fourth row and the first column) from blocks B to which the code “1,” “2,” “3,” “4,” or “A” is not assigned (i.e., tiles having patterns different from the unit pattern in the first row and the first column, the rotated unit patterns of the unit pattern, and the unit pattern in the fourth row and the fourth column). As shown in FIG. 7B, the code assignment unit 300 may generate rotated unit patterns Pb, Pc, and Pd by rotating the unit pattern Pa in the fourth row and the first column by predetermined angles.

The code assignment unit 300 may determine whether the unit pattern Pa in the fourth row and the first column is identical to the rotated unit patterns Pb, Pc, and Pd generated by rotating the unit pattern Pa. When the unit pattern Pa is not identical to the rotated unit pattern Pb, Pc, or Pd, the code assignment unit 300 may assign an identification code Ia to the unit pattern Pa and assign rotation identification codes Ib, Ic, and Id to the rotated unit patterns Pb, Pc, and Pd, respectively.

As a result, the unit pattern Pa in the fourth row and the first column may be assigned the identification code “a,” and the rotated unit patterns Pb, Pc, and Pd may be assigned the rotation identification codes “b,” “c,” and “d,” respectively.

Subsequently, as shown in FIG. 8, the map generator 400 may generate the code block map M by assigning the code “a” to the block B in the third row and the second column which has a pattern identical to the unit pattern Pa in the fourth row and the first column, assigning the code “b” to the block B in the second row and the fourth column, and assigning the code “c” to the block B in the fourth row and the second column.

As described above, the system 10 generates the simplified code block map M by coding the patterns of tiles in a space having floor tiles and wall tiles with repetitive patterns. Accordingly, it is possible to significantly reduce the amount of information of the code block map M and significantly reduce the amount of computation of the autonomous driving robot A using the code block map M.

A method of generating a code block map based on floor pattern recognition according to another exemplary embodiment of the present invention will be described in detail below with reference to FIG. 9.

For example, the method may be implemented by the system 10.

For example, the method of generating a code block map based on floor pattern recognition relates to a method of generating a code block map M using patterns of a floor on which the robot A travels, the method including an operation S100 in which the image acquisition unit 100 acquires a captured image E of a floor from the camera C, an operation S200 in which the unit pattern extractor 200 extracts unit patterns from patterns of the floor included in the captured image E, an operation S300 in which the code assignment unit 300 assigns predetermined identification codes to the unit patterns, and an operation S400 in which the map generator 400 generates blocks corresponding to the unit patterns and generates a code block map by matching the identification codes to the blocks corresponding to the unit patterns.

In the operation S300 in which the code assignment unit 300 assigns the predetermined identification codes, rotated unit patterns may be generated by rotating the unit patterns by a predetermined angle, and rotation identification codes may be assigned to the rotated unit patterns. The rotation identification codes may include information on the predetermined angle by which the unit patterns are rotated to be the rotated unit patterns.

In the operation S300 in which the code assignment unit 300 assigns the predetermined identification codes, no rotation identification code may be assigned to the rotated unit patterns when the unit patterns are identical to the rotated unit patterns.

In the operation S400 in which the map generator 400 generates the code block map, blocks B corresponding to the rotated unit patterns may be generated, and the code block map M may be generated by matching the rotation identification codes to the blocks B corresponding to the rotated unit patterns.

The present invention may include a computer-readable recording medium on which a program for performing the method on a computer is recorded.

### 2. System and Method for Recognizing Location and Orientation Based on Floor Pattern Code String

A system and method for recognizing a location and orientation of a robot based on a floor pattern code string according to an exemplary embodiment of the present invention will be described below with reference to FIG. 1 and FIGS. 10 to 16.

Description of technical spirit that overlaps the foregoing system 10 and method for generating a code block map based on floor pattern recognition or is easily deducible by those of ordinary skill in the art will be simplified or omitted.

Also, both the identification code and the rotation identification codes constituting the code block map M in the above description of the system 10 for generating a code block map based on floor pattern recognition will be referred to as “identification codes” below.

For example, the system may be mainly characterized in that travel images F captured through the camera C installed in the robot A are used to calculate a current location and travel direction of the robot A and monitor an operating state of the robot A in real time, and may include the robot A.

For example, as shown in FIG. 1, the robot A may include a controller A100 for controlling travel and operation of the robot A, a map acquisition unit A200, a travel image acquisition unit A300, a travel unit pattern extractor A400, a code string generator A500, and a calculator A600 which will be described in detail below.

The robot A may transmit and receive predetermined information and data to and from the foregoing system 10 for generating a code block map based on floor pattern recognition.

For example, the system may include the map acquisition unit A200 for extracting unit patterns from patterns of a floor in a predetermined space and acquiring a code block map M which is generated by assigning predetermined identification code to the unit patterns.

In other words, the map acquisition unit A200 may acquire the code block map M from the foregoing system 10 for generating a code block map based on floor pattern recognition.

Meanwhile, the system may further include a travel image acquisition unit A300 for acquiring the captured travel images F of the floor pattern from the camera C.

The travel images F may be images captured by the camera C installed in the robot A of which a location and orientation are to be calculated.

The travel image acquisition unit A300 may acquire the travel images F from the camera C in real time.

FIG. 10 is a set of schematic diagrams illustrating the travel images F. As shown in FIG. 10A, the robot A may travel in the predetermined space in an arrow direction (a bottom-to-top direction) and simultaneously capture the travel images F of the floor through the camera C.

FIG. 10B is an example of the travel images F acquired through the camera C, and patterns of the floor indicated by the arrow of FIG. 10A may be included as subjects of the travel images F.

As a result, the travel image acquisition unit A300 may acquire the travel images F shown in FIG. 10B from the camera C.

Meanwhile, the system may further include a travel unit pattern extractor A400 for extracting travel unit patterns from the floor pattern included in the travel images F.

More specifically, the travel unit pattern extractor A400 may detect boundaries of a plurality of tiles, which are subjects of the travel images F, and extract the travel unit patterns which correspond to the tiles on a one-to-one basis.

As a result, referring to FIG. 10B, the travel unit pattern extractor A400 may sequentially extract a travel unit pattern F1, a travel unit pattern F2, a travel unit pattern F3, and a travel unit pattern F4 in chronological order of the travel images F.

Meanwhile, when a plurality of tiles are included as subjects in the travel images F, the travel unit pattern extractor A400 may extract travel unit patterns from tiles including all boundaries (e.g., tiles having all four boundaries in FIG. 10B).

Meanwhile, the system may further include the code string generator A500 for generating a floor pattern code string by identifying predetermined travel identification codes corresponding to the travel unit patterns.

More specifically, the code string generator A500 may assign the predetermined travel identification codes to the plurality of travel unit patterns to generate a floor pattern code string in which the travel identification codes are combined.

For example, the code string generator A500 may compare the travel unit pattern F1 extracted from FIG. 10B with the plurality of unit patterns P1, P2, P3, and P4 included in the code block map M as shown in FIG. 11 and assign a travel identification code G1 of “1,” which is the same as the identification code I1 assigned to the unit pattern P1 identical or most similar to the plurality of unit patterns P1, P2, P3, and P4, to the travel unit pattern F1.

Similarly, the code string generator A500 may compare the travel unit patterns F2 and F3 extracted from FIG. 10B with the plurality of unit patterns P1, P2, P3, and P4 included in the code block map M and assign a travel identification code G4 of “4,” which is the same as the identification code I4 assigned to the unit pattern P4 identical or most similar to the plurality of unit patterns P1, P2, P3, and P4, to the travel unit patterns F2 and F3.

Also, similarly, the code string generator A500 may compare the travel unit pattern F4 extracted from FIG. 10B with the plurality of unit patterns P1, P2, P3, and P4 included in the code block map M and assign a travel identification code G3 of “3,” which is the same as the identification code I3 assigned to the unit pattern P3 identical or most similar to the plurality of unit patterns P1, P2, P3, and P4, to the travel unit pattern F4.

Consequently, as shown in FIG. 12, the code string generator A500 may assign the travel identification codes “1,” “4,” “4,” and “3” to the travel unit patterns F1, F2, F3, and F4 extracted from FIG. 10B and finally generate a floor pattern code string sequentially including “1, 4, 4, and 3.”

Meanwhile, the system may include the calculator A600 for calculating a location and orientation of the robot A by comparing the floor pattern code string with the identification codes of the code block map M.

More specifically, as an element for calculating the location and orientation of the robot A, the calculator A600 may compare the floor pattern code string of, for example, “1, 4, 4, and 3,” with the identification codes of the blocks B included in the code block map M and calculate an area of the code block map M having the same order of identification codes as the floor pattern code string, thus calculating the location and orientation of the robot A on the code block map M.

FIG. 13 shows an example in which the calculator A600 calculates identification codes corresponding to the floor pattern code string of “1, 4, 4, and 3” in the code block map M. The calculator A600 may recognize a combination of identification codes which is the same as the floor pattern code string of “1, 4, 4, and 3” in the plurality of identification codes vertically and horizontally arranged in the code block map M, and as a result, it is possible to calculate that the robot A is moving in an arrow direction shown in FIG. 3.

Meanwhile, FIG. 14A shows an example in which the robot A does not move in a bottom-to-top direction but moves in a left-to-right direction in FIG. 10A. The camera C of the robot A moving in the arrow direction of FIG. 14A may capture travel images F as shown in FIG. 14B.

In this case, in the same way as described above, the travel unit pattern extractor A400 may sequentially extract travel unit patterns F1, F2, F3, and F4. As shown in FIG. 15, the code string generator A500 may generate a travel identification code G2 of “2” for the travel unit pattern F1, generate the travel identification code G4 of “4” for the travel unit pattern F2, generate the travel identification code G3 of “3” for the travel unit pattern F3, and generate the travel identification code G3 of “3” for the travel unit pattern F4, resulting in the floor pattern code string of “2, 4, 3, and 3.”

Accordingly, the calculator A600 may search the code block map M for the floor pattern code string of “2, 4, 3, and 3” to calculate the location and orientation of the robot A.

However, as shown in FIG. 13, the code block map M does not have the identification codes of “2, 4, 3, and 3” in a bottom-to-top direction, a top-to-bottom direction, a left-to-right direction, or a right-to-left direction (a horizontal or vertical direction). As a result, the floor pattern code string may not match the identification codes of the code block map M.

In this case, that is, when the floor pattern code string does not match the identification codes of the code block map M, the calculator A600 may, for example, generate a corrected floor pattern code by correcting the travel identification codes using a predetermined rotation value and compare the corrected floor pattern code string with the identification codes of the code block map M to calculate the location and orientation of the robot A.

More specifically, the calculator A600 may generate the corrected floor pattern code string of “3, 1, 4, and 4” by adding 1 to the travel identification codes constituting the floor pattern code string of “2, 4, 3, and 3” as the rotation value for rotating the travel identification codes 90 degrees clockwise, generate the corrected floor pattern code string of “4, 2, 1, and 1” by adding 2 as the rotation value for rotating the travel identification codes 180 degrees clockwise, and generate the corrected floor pattern code string of “1, 3, 2, and 2” by adding 3 as the rotation value for rotating the travel identification codes 270 degrees clockwise.

The calculator A600 may compare the generated corrected floor pattern code string with the identification codes of the code block map M and calculate on the basis of the code block map M shown in FIG. 13 that the robot A is moving in a left-to-right direction in the third row of the code block map M matching “3, 1, 4, and 4” obtained by adding 1 to the travel identification codes as the rotation value for rotating the travel identification codes 90 degrees clockwise.

Meanwhile, according to another method, when the floor pattern code string does not match the identification codes of the code block map M, the calculator A600 may generate a rotated code block map M by correcting the identification code of the code block map M using the predetermined rotation value and compare the floor pattern code string with the identification codes of the rotated code block map M to calculate the location and orientation of the robot A.

More specifically, as described above with reference to FIG. 5B, the calculator A600 may generate the rotated code block map M by adding 1 to the travel identification codes constituting the code block map M shown in FIG. 13 as the rotation value for rotating the travel identification codes 90 degrees clockwise, generate the rotated code block map M by adding 2 as the rotation value for rotating the travel identification codes 180 degrees clockwise, and generate the rotated code block map M by adding 3 as the rotation value for rotating the travel identification codes 270 degrees clockwise.

The calculator A600 may compare the floor pattern code string of “2, 4, 3, and 3” with the identification codes of the generated rotated code block map M and calculate that the robot A is moving in a left-to-right direction in the third row of the code block map M matching the identification codes of “2, 4, 3, and 3” obtained by rotating the code block map M 270 degrees clockwise (90 degrees counterclockwise).

In this way, the system can calculate the location and orientation of the robot A very rapidly and easily by comparing the code block map M including the previously generated identification codes with the floor pattern code string which is generated after floor patterns in the captured images acquired in real time are coded.

Meanwhile, it has been described above that the code string generator A500 generates the floor pattern code string in which four travel identification codes are combined, but the number of travel identification codes is not limited to four.

More specifically, the code string generator A500 may change the number of travel identification codes included in the floor pattern code string according to any one of the types and number of identification codes included in the code block map M.

For example, the code string generator A500 may change the optimized number of travel identification codes included in the floor pattern code string according to whether there are many types of identification codes in the horizontal and vertical directions in the code block map M (e.g., the types of minimum numbers of combinations of codes of 1, 2, 3, 4, a, b, c, d, and the like combined in horizontal and vertical directions for unique code strings) and whether there are a large number of identification codes (e.g., the number of all rows and columns in the code block map M).

The calculator A600 can accurately calculate a travel direction (an angle of travel based on a tile) of the robot A through using an angle with respect to a boundary of the tile in the travel images F and also calculate a travel distance, a speed, and the like using the number of tiles, the size of tiles, and the like.

Meanwhile, the present invention may further include a method of recognizing a location and orientation of the robot A based on a floor pattern code string.

For example, the method relates to a method of recognizing a location and orientation of the robot A using floor patterns imaged through the camera C installed in the robot A which travels in a predetermined space. The method may be implemented by the foregoing system for recognizing a location and orientation of the robot A based on a floor pattern code string.

For example, the method relates to a method of recognizing a location and orientation of the robot A on the basis of floor patterns imaged through the camera C installed in the robot A which travels in a predetermined space and may include, as shown in FIG. 16, an operation S100 in which the map acquisition unit A200 extracts the unit patterns from a floor of the predetermined space and acquires the code block map M by assigning the predetermined identification codes to the unit patterns, an operation S200 in which the travel image acquisition unit A300 acquires travel images F of captured floor patterns from the camera C, an operation S300 in which the travel unit pattern extractor A400 extracts travel unit patterns from the floor patterns included in the travel images F, an operation S400 in which the code string generator A500 generates a floor pattern code string by identifying predetermined travel identification codes corresponding to the travel unit patterns, and an operation S500 in which the calculator A600 calculates a location and orientation of the robot A by comparing the floor pattern code string with the identification codes of the code block map M.

In the operation S500 in which the calculator A600 calculates the location and orientation of the robot A, when the floor pattern code string does not match the identification codes of the code block map M, a corrected floor pattern code may be generated by correcting the travel identification codes using a predetermined rotation value, and the corrected floor pattern code string may be compared with the identification codes of the code block map M to calculate the location and orientation of the robot A.

Alternatively, in the operation S500 in which the calculator A600 calculates the location and orientation of the robot A, when the floor pattern code string does not match the identification codes of the code block map M, a rotated code block map M may be generated by correcting the identification code of the code block map M using a predetermined rotation value, and the floor pattern code string may be compared with the identification codes of the rotated code block map M to calculate the location and orientation of the robot A.

In the operation S400 in which the code string generator A500 generates the floor pattern code string, the number of travel identification codes included in the floor pattern code string may be changed according to at least one of the types and number of identification codes included in the code block map M.

In addition, the present invention may further include a computer-readable recording medium on which a program for causing a computer to perform the method of recognizing a location and orientation of the robot A based on a floor pattern code string is recorded.

A system for recognizing a location and orientation of a robot based on a floor pattern code string according to an exemplary embodiment of the present invention can rapidly determine a location and orientation of a robot by reducing the amount of computation of travel environment information using preset codes for patterns in a space having floor tiles and wall tiles with repetitive patterns.

Effects of the present invention are not limited to that described above, and other effects which have not been described will be clearly understood by those skilled in the technical field to which the present invention pertains from this specification and the accompanying drawings.

Although configurations and features of the present invention have been described above on the basis of exemplary embodiments of the present invention, the present invention is not limited thereto, and it is apparent to those of ordinary skill in the art that various modifications or alterations can be made without departing from the spirit of the present invention. Therefore, such modifications or alterations fall within the scope of the following claims.

What is claimed is:

1. A system for generating a code block map based on floor pattern recognition using patterns of a floor on which a robot travels, the system comprising:
an image acquisition unit configured to acquire a captured image of a floor from a camera;
a unit pattern extractor configured to extract unit patterns from patterns of the floor included in the captured image;
a code assignment unit configured to assign predetermined identification codes to the unit patterns; and
a map generator configured to generate blocks corresponding to the unit patterns and generate a code block map by matching the identification codes to the blocks corresponding to the unit patterns.

2. The system of claim 1, wherein the code assignment unit generates rotated unit patterns by rotating the unit patterns by a predetermined angle and assigns rotation identification codes to the rotated unit patterns, and
the map generator generates blocks corresponding to the rotated unit patterns and generates the code block map by matching the rotation identification codes to the blocks corresponding to the rotated unit patterns.

3. The system of claim 2, wherein the rotation identification codes include information on the predetermined angle by which the unit patterns are rotated to be the rotated unit patterns.

4. The system of claim 2, wherein the code assignment unit assigns no rotation identification code to the rotated unit patterns when the unit patterns are identical to the rotated unit patterns.

5. A method of generating a code block map based on floor pattern recognition using patterns of a floor on which a robot travels, the method comprising:
acquiring, by an image acquisition unit, a captured image of a floor from a camera;
extracting, by a unit pattern extractor, unit patterns from patterns of the floor included in the captured image;
assigning, by a code assignment unit, predetermined identification codes to the unit patterns; and
generating, by a map generator, blocks corresponding to the unit patterns and generating a code block map by matching the identification codes to the blocks corresponding to the unit patterns.

6. The method of claim 5, wherein the assigning of the predetermined identification codes comprises generating rotated unit patterns by rotating the unit patterns by a predetermined angle, and assigning rotation identification codes to the rotated unit patterns, and
the generating of the code block map comprises generating blocks corresponding to the rotated unit patterns and generating the code block map by matching the rotation identification codes to the blocks corresponding to the rotated unit patterns.

7. The method of claim 6, wherein the rotation identification codes include information on the predetermined angle by which the unit patterns are rotated to be the rotated unit patterns.

8. The method of claim 6, wherein the assigning of the predetermined identification codes comprises assigning no rotation identification code to the rotated unit patterns when the unit patterns are identical to the rotated unit patterns.

9. A system for recognizing a location and orientation of a robot, which travels in a predetermined space, based on a floor pattern code string using floor patterns imaged through a camera installed in the robot, the system comprising:
a map acquisition unit configured to extract unit patterns from floor patterns of the predetermined space and acquire a code block map which is generated by assigning predetermined identification codes to the unit patterns;
a travel image acquisition unit configured to acquire a travel image of the floor patterns imaged through the camera;
a travel unit pattern extractor configured to extract travel unit patterns from the floor patterns included in the travel image;
a code string generator configured to generate a floor pattern code string by identifying predetermined travel identification codes corresponding to the travel unit patterns; and
a calculator configured to calculate a location and orientation of the robot by comparing the floor pattern code string with the identification codes of the code block map.

10. The system of claim 9, wherein, when the floor pattern code string does not match the identification codes of the code block map, the calculator generates a corrected floor pattern code string by correcting the travel identification codes using a predetermined rotation value and calculates the location and orientation of the robot by comparing the corrected floor pattern code string with the identification codes of the code block map.

11. The system of claim 9, wherein, when the floor pattern code string does not match the identification codes of the code block map, the calculator generates a rotated code block map by correcting the identification codes of the code block map using a predetermined rotation value and calculates the location and orientation of the robot by comparing the floor pattern code string with the corrected identification codes of the rotated code block map.

12. The system of claim 9, wherein the code string generator changes a number of travel identification codes included in the floor pattern code string according to at least one of types and a number of identification codes included in the code block map.

13. A method of recognizing a location and orientation of a robot, which travels in a predetermined space, based on a floor pattern code string using floor patterns imaged through a camera installed in the robot, the method comprising:
extracting, by a map acquisition unit, unit patterns from floor patterns of the predetermined space and acquiring a code block map which is generated by assigning predetermined identification codes to the unit patterns;
acquiring, by a travel image acquisition unit, a travel image of floor patterns imaged through the camera;
extracting, by a travel unit pattern extractor, travel unit patterns from the floor patterns included in the travel image;
identifying, by a code string generator, predetermined travel identification codes corresponding to the travel unit patterns and generating a floor pattern code string; and
calculating, by a calculator, a location and orientation of the robot by comparing the floor pattern code string with the identification codes of the code block map.

14. The method of claim 13, wherein the calculating of the location and orientation of the robot comprises, when the floor pattern code string does not match the identification codes of the code block map, generating a corrected floor pattern code string by correcting the travel identification codes using a predetermined rotation value, and calculating the location and orientation of the robot by comparing the corrected floor pattern code string with the identification codes of the code block map.

15. The method of claim 13, wherein calculating of the location and orientation of the robot comprises, when the floor pattern code string does not match the identification codes of the code block map, generating a rotated code block map by correcting the identification codes of the code block map using a predetermined rotation value and calculating the location and orientation of the robot by comparing the floor pattern code string with the corrected identification codes of the rotated code block map.

16. The method of claim 13, wherein the generating of the floor pattern code string comprises changing a number of travel identification codes included in the floor pattern code string according to at least one of types and a number of identification codes included in the code block map.

17. A non-transitory computer-readable recording medium on which a program for performing the method of claim 5 on a computer is recorded.

18. A non-transitory computer-readable recording medium on which a program for performing the method of claim 13 on a computer is recorded.
